(19) United States
(12) Patent Application Publication
(10) Pub. No.: US 2011/0029563 A1
(43) Pub. Date: Feb. 3, 2011

(54) SYSTEM AND METHOD FOR SEARCHING DATA SOURCES

(75) Inventors: Enrico Coiera, Sydney (AU); Victor Vickland, Sydney (AU)

Correspondence Address: SEYFARTH SHAW LLP, WORLD TRADE CENTER EAST, TWO SEAPORT LANE, SUITE 300, BOSTON, MA, 02210-2028, US

(73) Assignee: UNISEARCH LIMITED, Sydney (AU)

(21) Appl. No.: 12/876,565

(22) Filed: Sep. 7, 2010

Related U.S. Application Data
(63) Continuation of application No. 10/495,055, filed on Nov. 26, 2004, now abandoned.

(30) Foreign Application Priority Data
Nov. 20, 2001 (AU) PR 8948

(51) Int. Cl. G06F 17/30

(52) U.S. Cl. 707/779; 707/E17.014

(57) ABSTRACT

The present invention relates to a searching system and method arranged to search information available from one or more data sources. The searching system comprises a user interface and a storage means which is arranged to store search templates. The search templates include search profiles which include parameters which are arrange to direct the search in accordance with the nature of the search enquiry. The parameters may include the time period of data sources to be searched, the data sources to be used, and keywords delimiting with the search.

### CROSS-REFERENCES TO RELATED APPLICATION DATA

This application is a Continuation of U.S. patent application Ser. No. 10/495,055 filed on Nov. 26, 2004.

### FIELD OF THE INVENTION

The present invention relates to a system and method for obtaining information from data sources and, more particularly, but not exclusively, to a searching system and method for obtaining information from a plurality of heterogeneous data sources.

### BACKGROUND OF THE INVENTION

Systems for carrying out searches of computing system based data sources are well known. They include search systems which are available to search data sources over networks such as the Internet. They also include search systems arranged to search data sources such as databases which are provided for specialist searching, such as medical databases, which may or may not be available over networks such as the Internet.

For many systems, the information available from data sources is vast. In the medical area, for example, the amount of data available to medical professionals is enormous. It is very important that the medical professional be able to properly search this data in order for them to be able to make clinical decisions. One person cannot hope to personally keep up with developments in an area such as medicine and they must therefore rely on access to the available data sources. The search tools provided by any search system need to be adequate to facilitate an accurate and comprehensive search, which is able to be implemented speedily and without an inappropriate amount of effort required of the searcher. Presently available searching systems are not satisfactory in this regard. Present systems usually enable a searcher to input key words, combinations of key words and sometimes to select the data sources that are required to be searched. The accuracy and comprehensiveness of any such search depends for the most part on the skill and knowledge of the searcher. They must be able to decide on the appropriate key words to choose for the search, for example. It is plain fact that some people are more skilled in this than others. If they are to select the data sources available for the search, they must have the appropriate knowledge of the best data sources to search. If they haven't, the search will not be accurate or comprehensive. The selection of appropriate search criteria can also be extremely time consuming, particularly where the searcher is not particularly skilled or knowledgeable in searching.

### SUMMARY OF THE INVENTION

In accordance with a first aspect, the present invention provides a searching system arranged to search information available from a search space which includes at least one data source, the searching system comprising a user interface and a storage means arranged to store search templates, the search templates including pre-stored search parameters for controlling the search in accordance with the parameters and wherein a user is able to select a search template via the interface and the searching system is arranged to carry out the search in accordance with the pre-stored search parameters; the search templates including a plurality of user selectable search profiles, each search profile including parameters which are arranged to delimit a search space within the available search space whereby the search will occur within the delimited search space.

The provision of a search template(s) effectively enables searching “knowledge” about the most effective way to search to be stored in the system, by way of search parameters. A user then has access to this pre-stored “knowledge” to facilitate their search. For example, a template may have been previously prepared and stored by a user or system administrator having particular knowledge of a particular search area. This knowledge can be subsequently applied to carry out future searches. The skills, time and effort required of a novice user is therefore greatly reduced. If they wish to carry out a particular search, the user can look for an appropriate template, via the interface, for carrying out the search they have in mind, and select the template. It is not necessary for the user to define the parameters for every search, they can use the pre-stored template.

Preferably, the interface is arranged to enable new search templates to be prepared and added to the system, essentially providing a “library” of search templates. Preferably, new templates can be added by users of the system and preferably, the system is arranged so that templates prepared by different users can be shared between users.

Templates may also be prepared by users or system administrators who are specialized searchers.

The search templates include “search profiles” which include search parameters. These parameters may include the period of the search (what time period of data sources is to be searched), data sources to be used in the search, specific ways in which the query must be expressed for any particular data source including selection of a keyword expression language understood by the data source, the time that the system is to take to carry out the search, and how the results of the search are to be presented. The search profile may also include predetermined keywords that operate to focus the search.

The search profile parameters preferably specify how a search query must be expressed for each data source.

Preferably, the search profiles are arranged to encapsulate the nature of the search inquiry. One of the parameters preferably includes the subject matter of the search inquiry. For example, where the system is arranged to search within the medical domain the search profile may reflect the nature of the clinical inquiry e.g. “treatment” may search the database from the aspect of a “treatment” approach. The subject matter that is searched by the “treatment” profile will preferably include data sources which are relevant to treatment or have a treatment bias. Further, the time period which is searched may be governed by the nature of search inquiry eg. If the subject matter of the search may determine that the search period be limited to a particular period in history, the profile will be so limited.

Further, the profile may include key words limiting the search to reflect the nature of the clinical enquiry. For example, for a “diagnosis” profile, appropriate key words may be used in the search profile e.g. “diagnosis”.

Preferably, the system enables a user to enter key words (additional to those that may be provided with the profile).

Preferably, the system is arranged to categorize key words and to utilize key words in the search in dependence on the categorization. In one embodiment, a plurality of predefined fields are provided for entry of the key words, each of the fields defining a particular category. The searching system may assign different importance to key words depending upon the category. In one embodiment, the manner of the search applied by the category will depend upon the profile selected.

Profiles may be organized hierarchically. Such hierarchically organized profiles may include “parent” and “child” profiles. The child profile may provide a more “focused” search within a narrow area within the ambit of the parent profile. Preferably, the system interface enables the user to view the profiles within their hierarchy to enable selection of an appropriate profile for a search enquiry.

The search templates preferably further include “Saved Searches”, preferably including a plurality of key words for use by the searching system in carrying out the search. Keywords can may be arranged according to a predefined expression language, such as Boolean logical operators. Provision of this facility enables the user to proceed with a search without having to go to the time and trouble of selecting key words, or arranging them into the most appropriate expression using a predefined language like Boolean logic. Small alternations in keywords or keyword expressions provided to-search systems can result in substantial variation in search success, and the use of expert provided keyword sets for typical search topics enables novice searchers to use keywords preselected for their suitability to a specific type of search.

Preferably, the searching system is arranged to present the results of any search to a user via the interface.

Preferably, the search templates also operate to provide control parameters to control the way in which the results of the search are presented to the user.

Preferably, the searching system is arranged to enable users to amend search templates.

Preferably, the interface also includes a means whereby a user may carry out a standard search in a conventional manner.

Preferably, the searching system is arranged to carry out searches over a plurality of data sources. Preferably, the system may be arranged so that each data source or sources may be searched more than once for a particular search enquiry, either by parallel multiple searches or consecutively. Preferably, where the same data source or sources are searched more than once, each of the searches can have a different ratio between selectivity and specificity.

This enables multiple searches with different coverages and approaches to be carried out without any extra input from the user.

In accordance with a second aspect, the present invention provides, in a searching system which is arranged to search information available from a search space which includes at least one data source, a method of controlling the searching system by providing a search template including pre-stored search parameters for controlling the search in accordance with the parameters, the search templates including a plurality of user selectable search profiles, each search profile including parameters which are arranged to delimit a search space within the available search space whereby the search will occur within the delimited search space.

In accordance with a third aspect of the present invention, there is provided a computer program arranged, when loaded on a computing system, to control the computing system to provide a searching system in accordance with the first aspect of the present invention.

In accordance with a fourth aspect of the present invention, there is provided a computer readable medium providing a computer program in accordance with the third aspect of the present invention.

### BRIEF DESCRIPTION OF THE DRAWINGS

FIG. 1 is a schematic diagram demonstrating a system in accordance with an embodiment of the present invention;

FIG. 2 is a schematic diagram illustrating an architecture of the system of FIG. 1;

FIG. 3 is a flow diagram illustrating operation of the system of FIG. 1;

FIGS. 4 through 9 are diagrams representing “screens” for illustrating operation of the system of FIG. 1;

FIG. 10 is a diagram representing a screen display illustrating an aspect of operation of a further embodiment of the-present invention;

FIG. 11 is a diagram of an example display for illustrating another aspect of operation of the embodiment of FIG. 10; and

FIG. 12 is a diagram of an example display of search results for an example search.

### DESCRIPTION OF THE PREFERRED EMBODIMENT

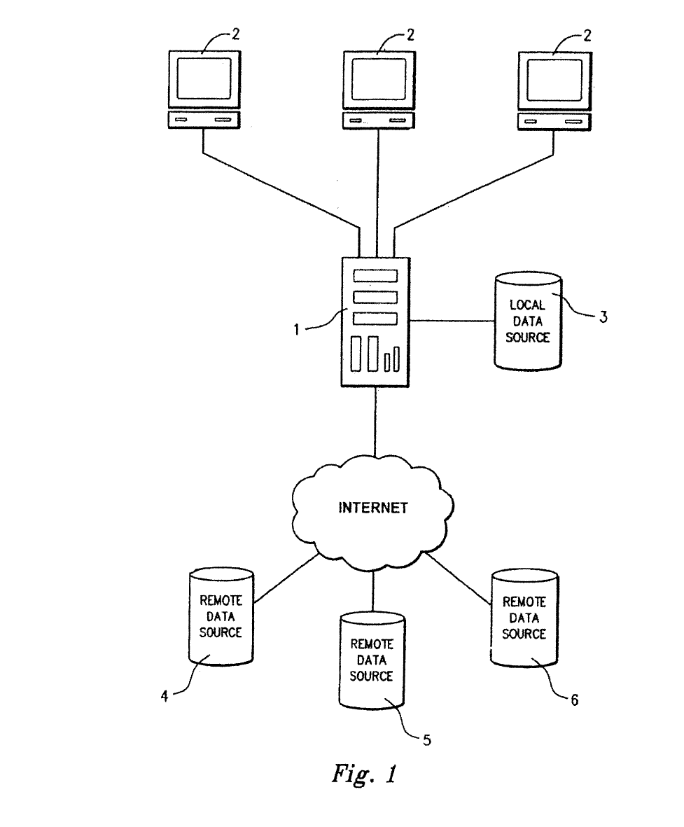

FIG. 1 illustrates a searching system in accordance with an embodiment of the present invention, that comprises a computing system 1 implementing the searching system, and providing a user interface to user terminals 2. The user terminals 2 may comprise any appropriate computing apparatus, and in this case are illustrated as being conventional PC's which may be linked to the computing system 1 by any appropriate link or network, and in this example the link is via the Internet.

The computing system 1 may also be implemented by any appropriate computing apparatus, and in this example is implemented as a server which is capable of providing web pages to user browsers loaded on user terminals 2, in a known manner.

The computing system 1 has access to data sources 3, 4, 5, 6, containing data which is able to be searched by the system 1. In this example, a local data source 3 is illustrated which is connected to the computing system 1 and which may comprise a conventional data base, and also sources 4, 5, 6 which are accessible over a network such as the Internet. Local or remote data sources are shown by way of example only and it will be appreciated that all data sources may be remote or all may be local, or as illustrated in FIG. 1, there may be a mixture of both types of data sources available to the system 1.

The system of the present invention may be capable of accessing and searching any available data source. In this example embodiment, however, the data sources store medical information, and the searching system is arranged to facilitate clinical searches that may be undertaken by medical professionals. It will be appreciated, however, that the system of the present invention may be applied to any subject matter field and any data sources, and is not limited to the domain of medicine.

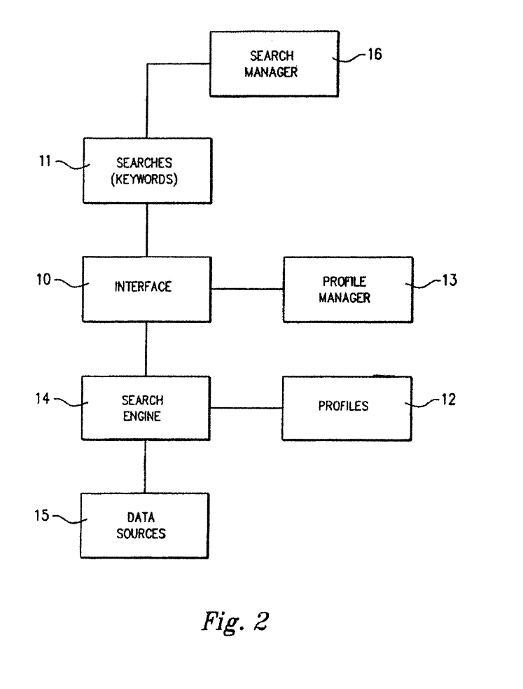

Referring to FIG. 2, the broad architecture of the system 1 comprises a user interface 10 which enables the user to access the searching system and which in this example comprises a web based interface provided by computing system 1 and browsers on the client systems 2. The system also includes means for storing search templates, which include pre-stored search parameters for controlling the search in accordance with the parameters, and which in this example include “searches” 11 and “profiles” 12. Each of the searches 11 includes one or more key words which have been pre-stored for particular types of searches which the user may wish to carry out, and the profiles include other parameters such as the dates of publications which the search may be limited to, the selection of the databases to be searched, other keywords which may facilitate limitations to a particular “profile”, and other parameters as will become more clear from the following detailed description.

The system architecture also includes a profile manager 13 for managing the profiles, and a search engine 14 for implementing the search in accordance with the search templates to search the database data sources 15.

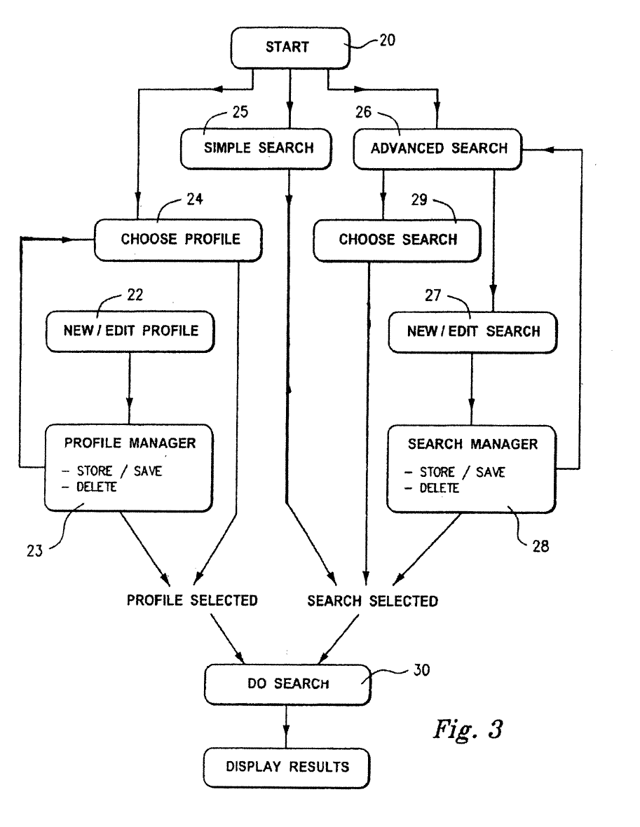

Operation of the system will now be described with reference to FIGS. 3 through 10.

Note that in some of the drawings which represent example screen shots, trademarks are used (“Quick Clinical”). It will be appreciated that the invention is not limited by any of this trademark matter.

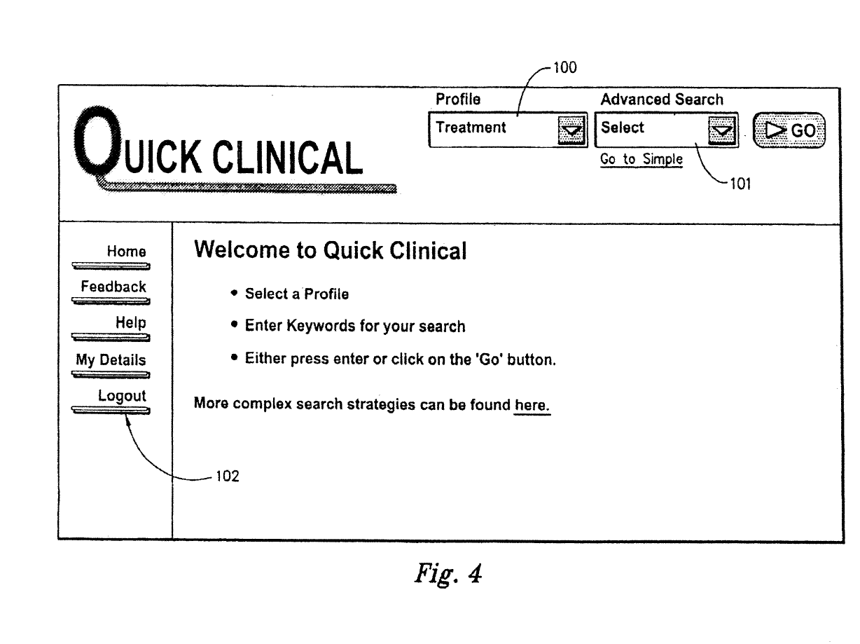

FIG. 4 represents a screen presented to a user system 2 via the interface 10 from which a user will enter instructions to carry out a search following “Start” (reference numeral 20, FIG. 3) system. This screen includes a profile window 100 to enable a user to select search profiles 12 and an advanced search window 101 which enables a user to select searches 11. The page also includes commands 102 which can be selected for other operations which are typical of Internet based systems, such as, for example, “Logout”.

In this medical based system, correct selection of the profile 12 is very important for accurate and clinically valid searches.

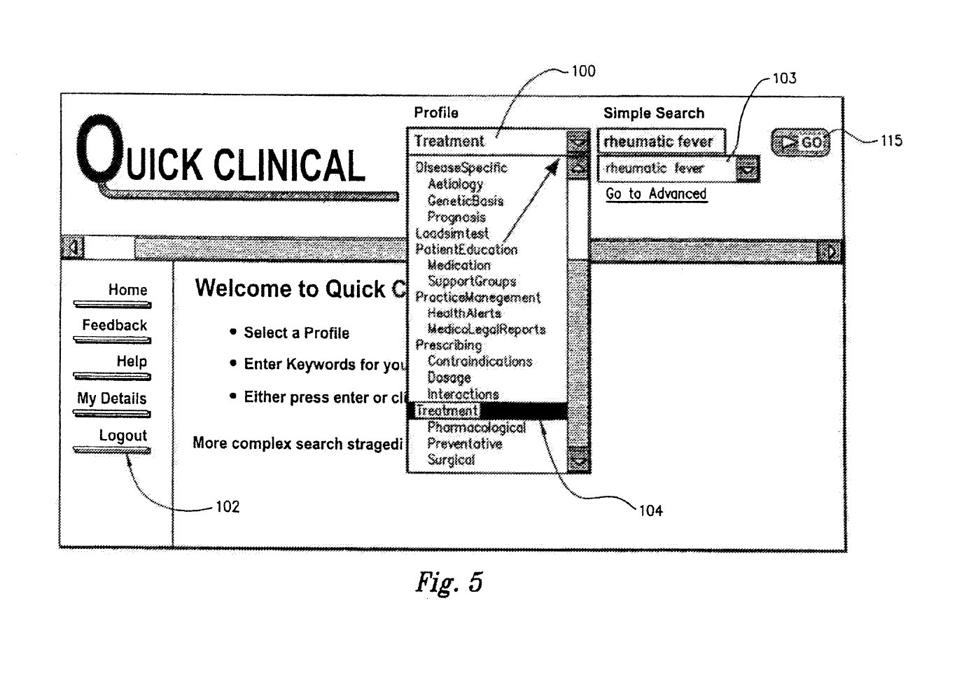

Selection of profile 12 is via a drop down list arrangement as illustrated at reference numeral 104 in FIG. 5. Note in FIG. 5 that the search has changed to a “Simple Search” 103. FIG. 4 illustrates at 101 the “Advanced Search” option. Simple Search and Advanced Search are discussed further in the following.

The pre-stored search profiles 12 are named for ease of reference as is shown in the drop down list 104. They are also organized hierarchically. For example, search profile “Treatment” is a “leading” search profile which will cause the searching system to look into data sources which contain information relevant to treatment rather than to diagnosis, aetiology or patient education, for example. The daughter search profiles of “Treatment”, shown here as “Pharmacological”, “Preventative” and “Surgical” will look into to treatment into these particular areas. There may be any number of levels of hierarchy, as will be appreciated.

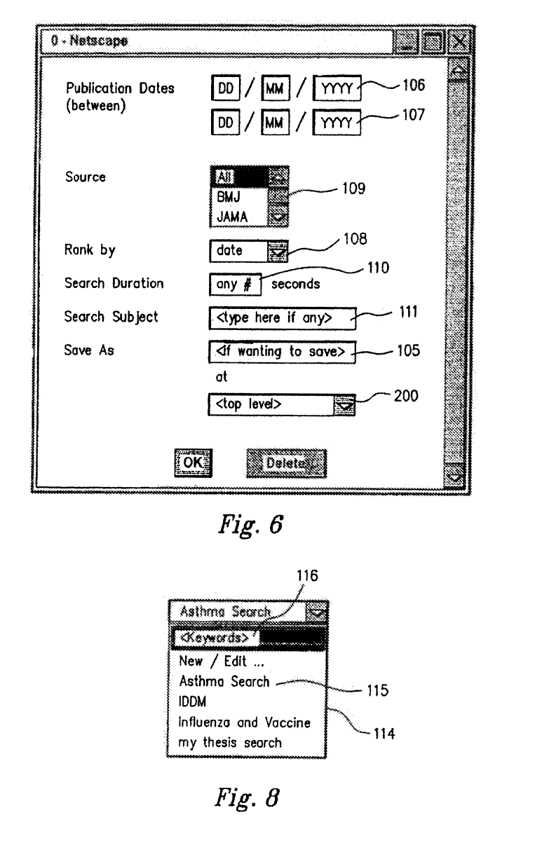

Any profile includes a number of parameters, which delimit the search according to the parameters. Profiles may be edited and new profiles may be created, via profile manager 13 (reference numerals 22 and 23 of FIG. 3, respectively). FIG. 6 is an illustration of a screen displayed to a user who wishes to add or amend a profile. In this embodiment, any profile has the following attributes:

A profile ID 105

Date to search articles from 106

Date to search articles to 107

How to sort or rank articles (e.g. by date, by title, by author, by journal-name etc) 108

Data sources to be searched by the search 109

The search duration 110

The search subject (for now this simply gets appended to search keywords) 111.

The hierarchy of the profile (denoted by the profile id of this profiles immediate parent) 200.

It will be appreciated that other embodiments may include other parameters that may be defined by a search profile. A major advantage of utilizing profiles is that the users “knowledge” of a particular area to be searched can effectively be stored in the system to be reused again by the user and other users. Preferably, search profiles may be available to a number of users e.g. medical professionals. Users may update or amend or add new profiles utilizing their particular knowledge of an area. Over time, therefore, the system increases its knowledge base. Searching becomes quTicker and more accurate. The search profile reflects the nature of the search enquiry. This embodiment, the search profile reflects the nature of the clinical enquiry. The search profile therefore provides a “focussing” of the search. The search profile may include search keywords to define the profile. It may be facilitated by search key words which are selected or entered by a user when carrying out a search.

If the user selects a profile name, the corresponding profile characteristics are fetched and displayed in a similar manner to the display of FIG. 6. The profile parameter values may be changed. A change in the profiles name (ID), however, has a special significance. If the name 105 is not change, then the profiles characteristics simply get updated. If the name, however, is changed, the profile is considered a new profile and it is saved as a immediate child of the profile initially displayed.

If users wish to change the profile name, they may do so by clicking on the “Rename” button (not shown but present in the table that displays the profile characteristics of another existing profile—it is merely the display of FIG. 6 with the addition of the “Rename” button). In this case, none of the other profile characteristics will change. This is done to separate the functionality of renaming a profile from simply changing the profile details.

At all times, if the profile name is left blank or with a default descriptive phrase, the new profile becomes temporary and is saved as “Current Profile” in a corresponding hierarchy level.

Once a profile has been selected (reference numerals 22, 23, 24 of FIG. 3) either by creating a new profile or choosing an already existing profile, then a “Search” needs to be selected. The system provides the option of a “Simple Search” (reference numeral 25 of FIG. 3) or a “Advanced Search” (reference numeral 26 of FIG. 3). If a Simple Search is selected (reference numeral 103, FIG. 5), the user merely enters key words that are appropriate for the search.

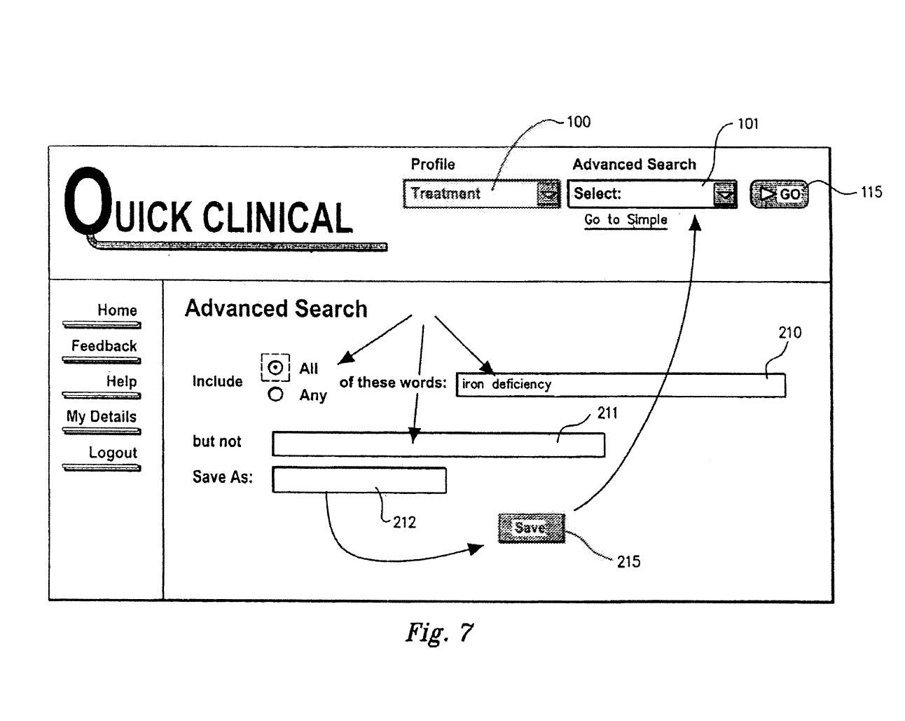

If the option of “Advanced Search” is chosen (see FIG. 7), the user has two alternatives.

In the first alternative, the user may create a new Advanced Search (reference numerals 27 and 2 of FIG. 3) via the Search Manager 16. FIG. 7 illustrates an example screen presented to the user for Advanced Search. The user enters key words in field 210. The key words may be words or phrases with AND OR NOT qualifiers. By typing a word or phrase in the “but not” 211 window, the search will exclude all sources containing this word or phrase.

The user may choose to save their Advanced Search-for future use by typing a name characteristic for this search in the “Save As” 212 window and clicking on the Save 213 button. The search is then saved for future use by the user and other users. Saving searches as a template adds further to the “Knowledge” of the system. Saved Searches can be created by users, shared between users and edited in a similar manner to Profiles.

The alternative option than a user creating their own Advanced Search, is for a user to select a pre-stored Advanced Search template (reference numeral 29 of FIG. 3). FIG. 8 illustrates the drop down list for the saved searches. The drop down list 114 includes names of all the saved searches that have been saved. Clicking on a name e.g. asthma search 215 selects that search and also gives a list of the key words 116 which the search includes. Once the search has been selected (27, 28, 29 of FIG. 3) the user may initiate the search (reference numeral 30 FIG. 3) by pressing the “Go” button 115. The search engine 14 then initiates the search based on the instructions from the search profile and the Search selected. The search engine 14 searches the data sources 15 and provides, in this embodiment, an XML document back to the system. The XML document is parsed and the results are displayed by the interface 10 in a user friendly manner.

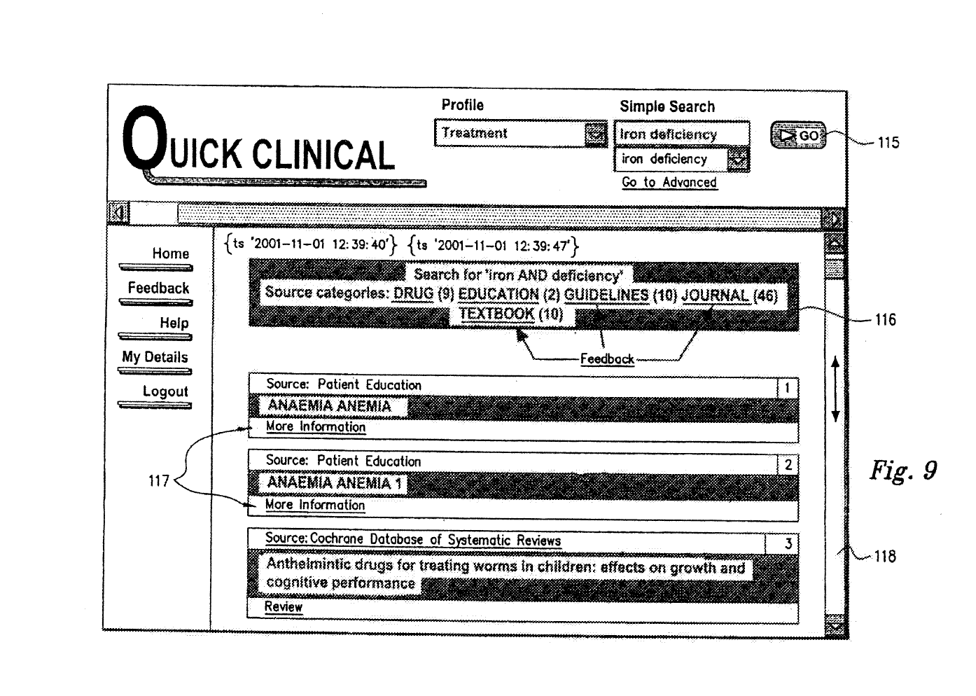

FIG. 9 illustrates an example display of search results. The layout of the display is effected by the selection of the original Search and Profile. At the very top of the display 116 a summary of the search is presented, which shows the data sources which were used and also names the search. The search results are then listed in accordance with the “ranking” stated in the profile in a list further down screen 117. Documents coming from different sources are grouped together to represent main categories such as guidelines, journals and text books. Numbers in brackets represent the amount of documents found in each category.

The user may view the list of retrieved documents by moving the scroll bar 118 up and down. By clicking on any of the underlined text “More Information” the user may view the details of the retrieved document. Further information could include various levels of detail such as an abstract or a link to a full document.

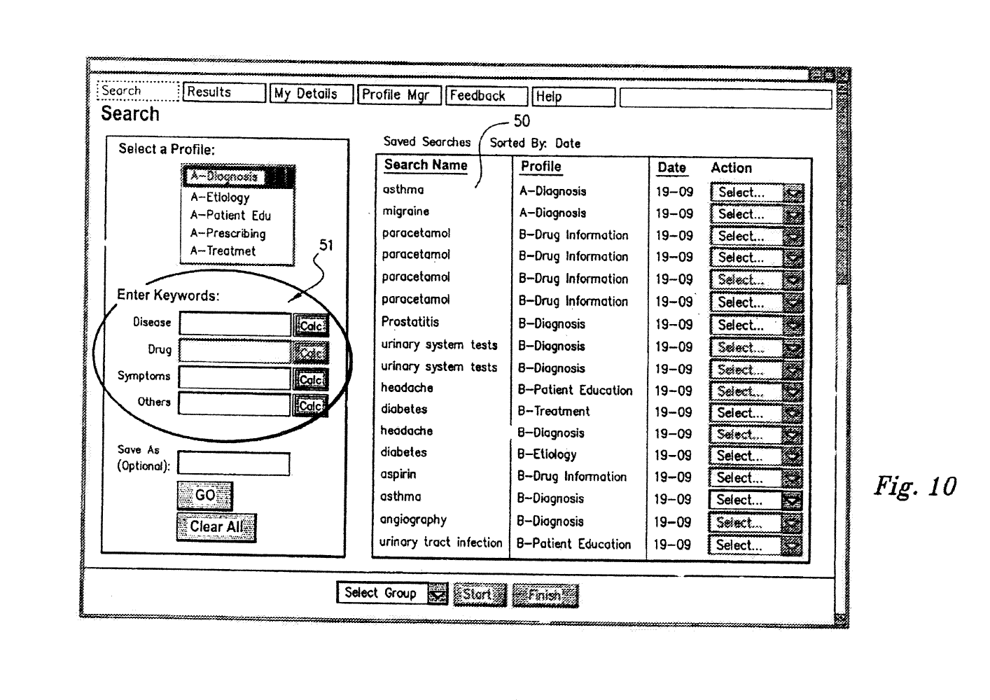

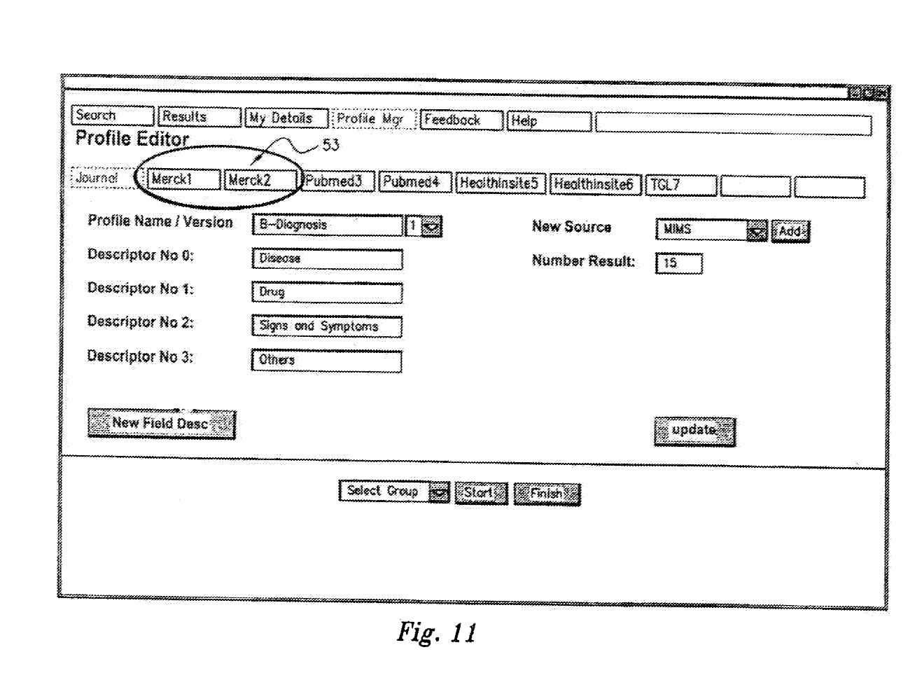

FIG. 10 illustrates an example display of a further embodiment of the present invention which does not include an option for “Advanced Search” or “Simple Search”. In this Profile Manager embodiment a saved search 50 can be selected or alternatively key words can be entered via a plurality of fields 51 which can be defined and arranged to provide a categorization for each of the key words to be entered. In the example illustrated, key words may be entered in the categories “Disease”, “Drug”, Symptoms” and “Others”.

The profile manager 13 may assign different importance or treat the key words in each category differently depending upon the profile that has been selected. For example, “A Disease” category key word is more important in “Diagnosis” profile and a “Drug” key word is more important in the “Prescribing” profile. The search can be affected by the category assigned to key words, as well as the profile.

A further facility of this further embodiment of the invention is the facility to search a data source more than once for each search inquiry. Referring to FIG. 11, this embodiment offers “match 1” “match 2” 53 searches for the same search enquiry. Match 1 and Match 2 apply different searching approaches as regards selectivity and specificity. For example, the first search “match 1” of the data source can be specified as extremely narrow and have high priority in the “mix” of results, e.g. by using all key words that have been typed in by the searcher and by searching in “titles”, and “abstracts” only. The second search “match 2’ can vary the ratio between selectivity and specificity, appropriate for the size and clinical importance of the source. Although this embodiment shows two different types of searches to be applied to the source, it will be appreciated that further searches having varied ratios between selectivity and specificity can be incorporated.

For the same search inquiry, therefore, several searches having different approaches to the same data source can be carried out.

The above embodiment has been specifically designed for use for medical professional for searching databases for clinical knowledge. It will be appreciated that the system of the present invention can be used to search any data source and is not limited to data sources containing medical knowledge.

The above embodiment is arranged to search data sources over a network such as the Internet. It will be appreciated that the present invention is not limited to a system which searches data sources over the Internet. Other embodiments may search databases locally to a computing system, may search over a network that is not the Internet, or may do a mixture of both.

In the above embodiment, search templates are separated into Search Profiles and Searches. It will be appreciated that a search template may be organized in different ways to this.

As discussed above, search profiles are not limited by the parameters which have been listed in the above embodiment. Many other search parameters are possible for profiles.

For example, a search profile may specify the order in which the results from different sources are presented by the user interface (e.g. source 1, then source 2, then source 3) whether they are intermingled according to a defined ranking criteria. Also the number of results to be reported back from a source can be specified. Further, a profile may specify which elements of a result are displayed e.g. for an article title, author, journal, elements, abstract or elements abstracted from text, and links to that article. These are all different sub components of the document, which the searching system may recognize from a predefined structure according to the stored document model, for example in XML which recognizes either tags in the retrieved document or searches for key words which identify the specific document component.

A profile may also indicate whether the sources are to be “linked”. For example, a CD-Rom version of a text book can be stored locally and be fast to access, and a Web version might be more up to date, but slower. A profile may define that the two sources are linked and integrate their results so that they speak with “one voice” to the user.

Further, some data sources may understand special commands e.g. the MEDLINE™ system recognizes defined words from MESH, and combines keywords in its own standard expression language and the profile could define specific use of key words for different sources

Note that, as discussed above profiles may have their own associated key words (preferably arranged into the most appropriate expressions) which will be used at all times with the search.

Other attributes that a profile may have include the following:

for each data source;

number of results to retrieve from this source;

weight (i.e. Contribution from this source to mix) maximum search time;

priority of the source in the mix;

lexical variant generation capability on/off.

The system may include a dictionary of words which may be selected from by the user as key words, in order to assist the user.

Another option for profiles is that they could include some parameters that are permanently fixed and cannot be edited by users. For example, it may be desirable to ensure that a particular profile for searching anatomy is always searches “Grays Anatomy” and the Search Profile may be fixed so that this text is always searched. Other aspects of the profile could be amended. On the other hand, the profile could include a parameter which specifies that a particular source is not to be searched.

As discussed above, search templates (including profiles and searches) can be shared between users. This can be done in any number of ways. For example, all new templates may be stored centrally by the system and shared by all, or stored centrally and only available to the user who created it, or available to a certain group (much like a bulletin board with a subscriber model). Alternatively, new templates may be stored locally on the user's system and only used by the creator. A further alternative is that all new templates may be stored centrally but down loaded to a local computer to be added to its library, so that there may be a separate template library to the core templates normally available--users browse the library to add more templates to their system to suit their particular needs.

There are also other options for sharing templates. The searching system of the present invention, it will be appreciated, may be implemented by any software/hardware arrangement that implements the functions described above.

It will be appreciated from the above description the present invention is in concerned with the user interface and the provision of search queries for searching multiple databases (the “front end”). The actual search engine (the “back end”) which implements the search queries formulated in accordance with the present invention, is not part of the present invention. Any appropriate search engine which can search the data source may be utilized to search in accordance with the search template.

The following two examples illustrate aspects of the embodiment of the present invention. One example relates to searching of clinical databases. The other example relates to searching of legal databases, in order to illustrate that the system can be applied across any subject matter.

### Example 1

The user may choose one of many available profiles, each of which has the capacity to modify the search query without user intervention.

TABLE 1
Table 1. Detailed design of the profile “Diagnosis”. #1#, #2#, #3#, #4# indicate
the content typed by the users as keywords.

| Source | P | W | R | Search Settings |
|---|---|---|---|---|
| Merck1 | 1 | 1 | 5 | (#1# AND #3# AND #4#) AND+ (“diagnosis” OR “symptoms and |
| | | | | signs” OR “laboratory findings” OR “classification”) |
| Merck2 | 2 | 2 | 10 | (#1# AND #3#) AND+ (“diagnosis” OR “symptoms and signs” OR |
| | | | | “laboratory findings” OR “classification”) |
| PubMed3 | 3 | 1 | 10 | #1# ATTR+ [Title] AND #3# ATTR+ [Title/Abstract] AND #4# |
| | | | | ATTR+ [Title/Abstract] ATTR+/diag Practice Guidelines English |
| | | | | 10 years Human |
| PubMed4 | 4 | 2 | 10 | #1# ATTR+ [Title] AND (#3# OR #4#) ATTR+ [Title/Abstract] |
| | | | | ATTR+/diag English 10 years Human |
| HealthInsite5 | 5 | 2 | 10 | #1# AND #3# |
| HealthInsite6 | 6 | 2 | 10 | #1# OR #3# |
| TGL7 | 7 | 2 | 10 | #1# AND (#3# OR #4#) AND+ “diagnosis” |

There are three ways in which the profile reflects the nature of the search by adding additional search words to the search query by restricting the search space within the selected source by allowing to perform search only on sources which are most relevant to the nature of the medical enquiry.

The example above shows the profile “diagnosis”. Additional words such as “diagnosis” or ‘signs and symptoms” are being included in the search query without user intervention. The search space restriction is illustrated by using words such as “Practice Guidelines—English—10 years—Human” applied to the PubMed source, once again transparent to the user.

Only four out of 8 sources are used in the profile “Diagnosis” because only these sources contain information most relevant to the medical enquiries in the area of differential diagnosis.

The Keywords.

The properly defined search query requires that the user makes a choice of the search profile and types at least one keyword. However user may attempt to make much more complex search using many keywords at the same time. The user interface allows to streamline this process of entering the keywords by. Providing multiple entry fields with descriptors Providing “Builder” functionality which assists in making more complex Boolean logic enquiries.

Categorization of the Keywords.

A unique feature of the user interface is the categorization of keywords

| | |
|---|---|
| Disease | Asthma |
| Drug | Salbutamol |
| Symptoms | Cough |
| Others | Child |

The above example indicates that different keywords can be entered in separate entry fields according to their meaning Disease names are expected to by entered in the field with the ‘disease” descriptor or drug names to be entered in the field with the “drug” descriptor.

This unique approach allows the system to “know” the category to which each keyword belongs. That knowledge is use in the profile engineering to assign different importance to keyword categories (e.g. keyword entered as “disease” is of primary importance in the “Diagnosis” and “Treatment” profile but the drug name is most important in “Drug info” profile).

Multiple Search in the Same Source.

The information contained in any specific source is usually structured according to certain pre-defined rules. For example textbooks are structured as sections, chapters, sub-chapters, paragraphs. Other sources such as PubMed may use purpose-build lists of key terms such as MeSH to promote the better search techniques.

The system allows to explore such pre-defined structure of the data source by conducting multiple searches on the same source with various level of specificity and precision. An example of this would be to search for the main keyword first in the titles, then in the abstract or summary, and then in the main body of the text. The results are then checked for duplicates and displayed together in the pre-defined order.

TABLE 2
Source

| | |
|---|---|
| Merck1 | This source is searched with a very narrowly defined criteria |
| | e.g., looking for all keywords in the title. |
| Merck2 | This search is defined more broadly e.g., looking only for |
| | the main keywords and within the bigger search space such |
| | as abstract or even whole text. |
| PubMed3 | |
| PubMed4 | |

Table 2 above illustrates this approach with two sources, allowing for two searches in each source in response to the single user enquiry. Theoretically there is no limit on the amount of multiple searches conducted on one source.

Search Results.

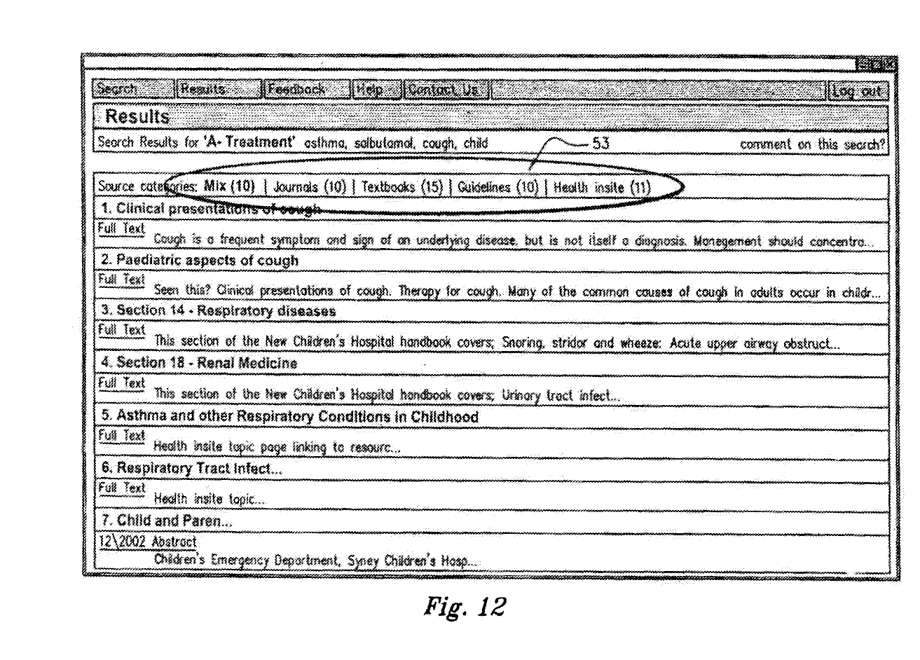

The results obtained in response to the search query are grouped according to a certain criteria. The examples of the categories are: Journals, Textbooks and Guidelines. (ref numeral 300, FIG. 12). New categories can be created in future as well as the new functionality to performed the secondary searches (on previously retrieved results).

The user may choose to read abstract of the selected PubMed article or full text info retrieved from the other sources as illustrated in FIG. 12.

### Example 2

Similar search capacity as employed in the medical field of knowledge can be used in the field of legal enquiries. The capacity of using multiple sources and multiple entry fields would be most suitable for complex, multi-indexed data sources. One of the hypothetical examples can be illustrated as follows:

| | |
|---|---|
| Profile | Family |
| Plaintiff | Prosecutor |
| Defendant | Bad Company |
| Judge | Judy |
| Others | e-commerce |

Examples of hypothetical search profiles may include: Criminal, Family, Fraud and Legislation. Essentially any well defined type of legal enquiry can became a pre-defined search profile.

Modifications and variations as would be apparent to a skilled addressee are deemed to be within the scope of the present invention.

What is claimed is:

1. A searching system arranged to search information available search space which comprises at least one heterogeneous database;
the searching system comprising a user interface, a storage means, a plurality of search templates stored by the storage means, each stored search template comprising one or more parameters;
wherein the user interface is arranged to enable a user to select a search template;
wherein the searching system is arranged to carry out a search in accordance with the pre-search parameters; and
wherein the search templates comprise a, plurality of user selectable search profiles representing subject matter characterization of respective searches: said profiles including identity of specific heterogeneous databases to be searched and parameters directed to implementing the search in each specific identified database.

2. The searching system in accordance with claim 1, the interface including means enabling new search templates to be added to the system by users.

3. The searching system in accordance with claim 1, the system being arranged so that search templates may be accessed by a plurality of users.

4. The searching system in accordance with claim 1, wherein the search templates further comprise templates arranged to store searches comprising a plurality of key words for use by the searching system in carrying out the search whereby, in operation, a user may select a template stored search as the user specified search.

5. The searching system in accordance with claim 1, including search entry means enabling the user to enter search data to enable a search to be carried out, whereby, in operation, the search data comprises the user specified search.

6. The searching system in accordance with claim 5, wherein the search data comprises key words.

7. The searching system in accordance with claim 1, wherein the search profiles include pre-stored search parameters which are arranged to direct the search in accordance with the nature of the search enquiry.

8. The searching system in accordance with claim 1, wherein the search profiles include a plurality of pre-stored search parameters for applying the search knowledge.

9. The searching system in accordance with claim 1, wherein the search profiles are programmable whereby to enable adjustment of the search parameters.

10. The searching system in accordance with claim 1, wherein search profile parameters include keywords or keyword expressions.

11. The searching system in accordance with claim 1, wherein search profile parameters specify a time period of data sources to be searched.

12. The searching system in accordance with claim 1, wherein search profile parameters include a time that the system is to take to carry out the search.

13. The searching system in accordance with claim 1, wherein search profile parameters specify how a search query must be expressed for the data source, and the search profile operates to generate a search query, utilizing the user specified search, that is in the appropriate expression form.

14. The searching system in accordance with claim 1, wherein the search profile includes parameters instructing how search results are presented.

15. The searching system in accordance with claim 1, including interface means enabling the user to enter key words into one of a plurality of predetermined categories.

16. The searching system in accordance with claim 15, the searching system being arranged to utilize the key words in dependence on their categorization.

17. The searching system in accordance with claim 1, being wherein the search profile includes parameters instructing searching of a data source a plurality of times for a single user specified search.

18. The searching system in accordance with claim 17, wherein each one of the plurality of searches of the same data source is arranged to have different selectivity and specificity of the source.

19. In a searching system which is arranged to search information available from a search space' which includes at least one heterogeneous database, a method of searching comprising;
receiving a user specified search; and
applying a user selected search template to implement the search in accordance with search knowledge, the user selected search template comprising a search profile representing a subject matter categorization of said search, said search profile comprising one or more parameters for applying the search knowledge to the search specified by the user by identifying at least one heterogeneous database and procedures for searching the at least one heterogeneous database as a function of the search profile and parameters directed specifically to implementing the search in each respective identified database.

20. The method in accordance with claim 19, wherein the search profiles are programmable and the method comprises the further step of a user adjusting the search parameters of a search profile.

21. The method in accordance with claim 19, wherein the search profile includes pre-stored search parameters which are arranged to direct the search in accordance with the nature of the search enquiry.

22. The method in accordance with claim 19, wherein the search profile includes a plurality of pre-stored search parameters for applying the search knowledge.

23. The method in accordance with claim 19, wherein the search profile is programmable to enable adjustment of the search parameters.

24. The method in accordance with claim 19, wherein the search profile parameters include keywords or keyword expressions.

25. The method in accordance with claim 19, wherein the search profile parameters specify a time period of data sources to be searched.

26. The method in accordance with claim 19, wherein the search profile parameters include a time that the system is to take to carry out the search.

27. The method in accordance with claim 19, wherein the search profile parameters specify how a search query must be expressed for the data source, and the search profile operates to generate a search query, utilizing the user specified search, that is in an appropriate expression form.

28. The method in accordance with claim 19, wherein the search profile includes parameters instructing how search results are presented.

29. The method in accordance with claim 19, wherein the search profile includes parameters instructing searching of a data source a plurality of times for a single user specified search.

30. The method in accordance with claim 29, wherein each one of the plurality of searches of the same data source is arranged to have different selectivity and specificity of the source.

31. The searching system in accordance with claim 1, the system being arranged to enable search profiles to be shared and accessed by multiple users.

32. The method in accordance with claim 19, comprising the further step of sharing search profiles among multiple users.

33. The searching system according to claim 1, wherein further search parameters of the search parameters are selected from the group consisting of: a time period of data to be searched, predetermined keywords, and identification of keyword expression language understandable by the data source.

34. The searching system according to claim 1 wherein the profiles are organized hierarchically as parent profiles and corresponding child profiles.

35. The method according to claim 19, wherein further search parameters of the search parameters are selected from the group consisting of: a time period of data to be searched, predetermined keywords, and identification of keyword expression language understandable by the data source.

36. The method system according to claim 19, wherein the profiles are organized hierarchically as parent profiles and corresponding child profiles.

37. A computer implemented search system comprising:
at least one storage means;
at least one processor in communication with said at least one storage means;
a plurality of search profiles stored by the storage means, each of said profiles representing a subject matter characterization of said search and identifying at least one heterogeneous database to be searched by said search system;
said search profiles including procedures for searching said at least one heterogeneous database as a function of the search profile and parameters directed specifically to implementing the search in each respective identified database; and
a user interface enabling a user to select a search profile to generate a user specified search.

38. The computer executable search system according to claim 37, wherein further search parameters of the search parameters are selected from the group consisting of: a time period of data to be searched, predetermined keywords, and identification of a keyword expression language understandable by the at least one heterogeneous database.

39. The computer executable searching system according to claim 37, wherein the profiles are organized hierarchically as parent profiles and corresponding child profiles.

40. A computer implemented search system comprising:
at least one heterogeneous database;
a plurality of search profiles selectable by a user to perform a subject;
each of said search profiles representing a subject matter categorization of search including at least one search string adapted specifically to each of the at least one specific heterogeneous database.

41. A computer implemented search system wherein at least one of said search string includes content typed in by the users on key words.

42. A computer implemented search system wherein at lest one of said search sting includes additional search words as a function of the search subject matter categorization said profile.

43. A computer implemented search system wherein said profile restricts search space within at least one of said heterogeneous databases to reflect the subject matter categorization of said profile.
